(19) United States
(12) Patent Application Publication
(10) Pub. No.: US 2025/0272654 A1
(43) Pub. Date: Aug. 28, 2025

(54) Enhanced Probability RFID Inventory System

(71) Applicants: RICKEY NEAL WALKER, Harvest, AL (US); Barry Wayne Jones, Huntsviller, AL (US)

(72) Inventors: RICKEY NEAL WALKER, Harvest, AL (US); Barry Wayne Jones, Huntsviller, AL (US)

(21) Appl. No.: 18/955,971

(22) Filed: Nov. 21, 2024

Related U.S. Application Data
(60) Provisional application No. 63/549,571, filed on Feb. 4, 2024.

(51) Int. Cl. G06Q 10/087; G06K 7/10

(52) U.S. Cl. CPC G06Q 10/087; G06K 7/10297

(57) ABSTRACT

A movable Tower Inventory System which contains a number of RFID antennas mounted vertically along the tower. The Tower Inventory System is the moved along the front of storage racks to acquire information from RFID tags affixed to assets positioned on the storage rack. This information, existing inventory data and processing by the System enables the identification of a number of inventory items.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING

Not applicable

### STATEMENT REGARDING PRIOR DISCLOSURES BY THE INVENTOR

None

### BACKGROUND OF THE INVENTION

Modern-day commercial activity is very much dependent on the shipping and warehousing of various types of products and manufactured Items. As used herein, Item refers to any carton, package, case of one or more objects that is being individually labelled and tracked. It is also understood to be both singular and plural. Just-in-time manufacturing requires the highest level of efficiency in terms of managing the shipping and storage of Items.

One of the key elements is to have a large stockpile of Items stored in huge warehouses. Warehouses today can be larger than 800,000 square feet, a quarter of a mile long and have storage systems that can be 30 feet tall.

To benefit from the large number of Items being stored, one must know exactly how many of a particular Item is in the warehouse and exactly where it is stored. When orders come in, the vendor must quickly determine if they have the proper number of the ordered Items on hand. Even though computer tracking systems are efficient in monitoring the sales and receipt of Items, there periodically must be a reconciliation of the inventory. Reconciling means comparing an actual physical counting of the Items in the warehouse to what the computer tracking system states and correcting any discrepancies.

In addition, it is very important to know where the Items are in the warehouse. The nomenclature that describes features of the physical storage of a typical warehouse is now described. As used herein, Aisle is used to refer to a region running the length of one side of a linear shelving unit and directly in front of one face of another shelving unit. The physical space between two shelving units is comprised of two Aisles. One Aisle is located along the one side of the physical space between two shelving units and the other Aisle is located along the other side of the physical space between the same two shelving units. An Aisle can also refer to the space along the front of one side a shelving unit that had has no other shelving unit facing it. The shelving units are described herein as being linear. However, the Mobile Inventory System can accommodate shelving arrangements that have other geometries.

As used herein Bay refers to the space between two upright physical supports, with the supports being referred to as Bay Dividers, which extend from on or near the floor of the warehouse and upwards to the highest part of the shelving unit. Bay Dividers are spaced at various intervals along the length of a shelving unit. In many cases, Bay Dividers are spaced at regular intervals, but the spacing between Bay Dividers can be altered to accommodate Items of differing sizes. Bays are divided vertically by the placement of horizontal supports which are referred to as a Shelf or Shelves. A typical Bay might have as many as five or more Shelves.

The Location of an Item is identified by the Aisle, Bay, and Shelf that the Item is stored on. However, the naming convention of the Aisle, Bay and Shelf may vary between warehouses. Those numbers, which together constitute the Location, are recorded in whatever inventory tracking system is used and this inventory is referred to as the Predetermined Inventory (PI). Location is used in reference to the PI. The present invention determines a Scanned Location and a Most Probable Location which is discussed in detail herein. The word “location” when used herein in all lower-case letters, refers to a general physical position of an item, and does not refer to any to the Scanned Location or Most Probable Location as measured and determined by the present invention. Sometimes the Location information is mistakenly entered, or the Item is accidentally placed in the wrong location. If the Item is not where the PI indicates it should be, then much time is wasted physically inspecting the entire warehouse to find the Item. This is made even more time-consuming because many warehouse shelving systems are 20-30 feet high, and someone must gain access to the upper Shelves via some sort of movable ladder or mechanical lift. Sometimes pallets of material must be taken down or moved to access Items that are located toward the back of the Shelves and obscured by other Items. There have been other attempts to make a useful and efficient method of automating a warehouse inventory system.

U.S. Pat. No. 7,693,757, “SYSTEM AND METHOD FOR PERFORMING INVENTORY USING A MOBILE INVENTORY ROBOT”, describes a mobile inventory robot which is primarily designed to navigate through a retail store. The described robot includes an obstruction avoidance system, motorized drive wheels, a self-docking power recharging system, and very sophisticated imaging processing systems to read bar codes on shelves and capture images of products on the shelves. To identify a product, an image captured during an inventory process must be compared to the visual characteristics of the product (size, color, texture, images from multiple views) which has been previously entered into an inventory database.

It is not clear that the system can generate a count of the number of Items on a shelf. As shown in FIG. 7B the imaging camera can only see the Items that are in front of a group of similar Items. For instance, some Items 775 are in the back row and are therefore essentially invisible to the camera.

To efficiently and safely navigate the robot through the store, numerous sensors are required, such as ultra-sonic detectors, retroreflective detectors, infrared transmitters, and infrared receivers.

In addition, the navigation system may sometimes be unable to move the robot through the store and manual intervention by a human operator would be necessary to either remove the obstacle or reprogram the robot to avoid the obstacle.

The robot further includes a mechanical positioning system that can raise and lift the detection devices in order to read Items stored on higher shelves. Not only does this increase the time to conduct an inventory because of the time taken to raise and lower the detectors, but it also increases maintenance costs and the likelihood of mechanical failure.

Another attempt to produce an efficient inventory system is described in U.S. Pat. No. 9,939,816, “AUTOMATED INVENTORY TAKING MOVEABLE PLATFORM”. The automated moveable platform as described in the published application also utilizes many sensors. Shown in FIG. 1 is a light sensor 106, a radiation sensor 109, a camera 103, a humidity sensor 102, a temperature sensor 108, and a collision sensor 105. Further, the patent requires “at least one camera, an IR sensor, a laser ranging sensor, an ultrasound sensor, a collision sensor, a humidity sensor, a light sensor, a temperature sensor, a pressure sensor, a gas sensor, a radiation sensor, a radio frequency or Wi-Fi sensor, a positioning sensor.” Col 2, lines 6-15.

In addition, as described in Col 3, lines 46-55, the navigation system will adjust the speed and path of the robot depending on data about first-time identified objects and previously identified objects.

To increase the reliability of the detection system, one or more RFID antennas that are capable of moving and/or rotating horizontally or vertically. Such an antenna system increases costs and maintenance time.

The previously described inventory systems are very complicated. They require multiple sensors, image capture and analysis software, motorized drive mechanisms and sophisticated software to control the path of the robot and avoid obstacles.

Background Information about Radio Frequency Identification (RFID)

Radio Frequency Identification is a technology that utilizes radio waves to activate tags which contain RFID circuitry. These tags ordinarily do not include any power source, such as a battery, but are energized by the radio frequency (rf) energy emitted by an antenna which is driven by an RFID reader. The amount of power generated in the tag by the activating radio wave is small and short-lived. Normally, the tag will have just enough power to provide a single transmission of information back to the antenna. Once the tag is energized, it will transmit, via a radio wave, a unique ID number, and other information that the tag manufacturer decided to program into the tag. The unique ID number is encoded by various techniques known in the industry. That radio wave is received at the antenna and decoded by the reader, which is in electrical communication with a computer or other device having computer capabilities. The RFID reader alternates between transmitting energizing/activating rf energy and then switching to a receiving mode to receive/capture the response from the RFID Tag. This switching between activating and receiving can occur typically in the range of microseconds to milliseconds. Therefore, a particular RFID Tag can be activated and respond multiple times during the period that an RFID reader is moved past an Item. Currently there are RFID technologies that operate at Very Low Frequency (VLF 30-300 Hz), High Frequency (HF 3-30 MHz) and Ultra High Frequency (UHF 300-3000 MHz). The Mobile Inventory System normally operates in the UHF band between 902-928 MHz, but the Mobile Inventory System can operate in other frequency bands to meet special needs.

Although this invention will be described as utilizing RFID technology, any similar remote electronic identification could be utilized with the novel and non-obvious elements of the present invention and should be considered as being within the scope of the present invention.

### BRIEF DESCRIPTION OF THE SEVERAL VIEWS OF THE DRAWINGS

A better understanding of the present invention will be realized from the detailed description which follows, taken in conjunction with the accompanying drawings in which:

FIG. 1 shows a 45-degree angle front view of one embodiment of the present invention;

FIG. 2 shows a front view of one embodiment of the present invention with the upper cabinet doors open;

FIG. 3 shows a front view of the right side of one embodiment of the present invention with the upper right cabinet door open;

FIG. 4 shows a front view of one embodiment of the present invention with the lower cabinet door open;

FIG. 5 shows a back view of the lower portion of one embodiment of the present invention with the lower door open;

FIG. 6 shows a back view of one embodiment of the present invention with the lower door open;

FIG. 7 is a schematic of the power distribution system of one embodiment of the present invention;

FIG. 8 is a flow chart of the Scanning Operation of one embodiment of the present invention;

FIG. 9 is a flow chart of the Data Processing Operation of one embodiment of one embodiment of the present invention; and

FIG. 10 is a schematic of an overview of the general operation of one embodiment of the invention.

### BRIEF SUMMARY OF INVENTION

The Mobile Inventory System is based upon a new and useful method of performing an inventory by identifying the Most Probable Location for an Item. Details of the Most Probable Location and how it is determined are described in detail later herein but will be discussed in summary here. The present invention further includes the hardware and software necessary to perform the inventory and provide inventory data in both a computer file format and a printed format. As used herein, conducting an Inventory shall mean performing a simple, physical, manual identification and counting of Items in a warehouse or other storage area. A Reconciled Inventory shall mean updating an existing Inventory with data from a Scan by the present invention.

In a real-world situation, knowing if an Item is in the warehouse and approximately where it is located is a practical solution to day-to-day warehouse inventory management. The benefit of having precise location data does not justify the cost and complexity of a device and software that would provide that very precise location data.

This present method is based on determining the Most Probable Location of a specific Item based on the capture and analysis of multiple RFID Tag readings by the use of the Mobile Inventory System. The Mobile Inventory System is housed in the System Cart which is moved along the Aisle in front of a storage unit. As the System Cart moves down the Aisle, the RFID Tags are activated and send out the information that they are programmed to provide. The Mobile Inventory System then captures and stores the information transmitted by the activated RFID Tags that are placed on the Items that are positioned on the Shelves. Though the System Cart is discussed herein as being a user-pushed cart, other forms of achieving the scanning of the warehouse storage units could include, but are not limited to, movement by use of a forklift, a motorized self-propelled cart guided by the user, an entirely autonomous cart with preprogrammed information about the layout of the warehouse, a hand-held RFID scanner and even the use of drones with an RFID reader and antenna which could be programmed to move and position itself over the entire length and height of one or more storage units.

After the entire warehouse has been scanned, the data from the many thousands of RFID Tag responses is processed. This process of acquiring and storing the RFID Tag information, as well as other information, by moving one or more antennas across the face of one or more storage units shall be referred to as Scanning, Scan or Scanned. The data that is acquired shall be referred to as Tag Telemetry Data. The Tag Telemetry Data is compared to the existing inventory of the warehouse, referred to as the Predetermined Inventory (PI). Each of the unique RFID Tags is assigned to one of four categories by the processing of the Tag Telemetry Data. These four categories are: 1. Counted, 2. Gained, 3. Misplaced, and 4. Loss. The Counted category is determined first and is critical to the determination of the Most Probable Location.

Each individual Item has its own unique RFID Tag number. Each tag can be activated any number of times as the Mobile Inventory System moves through the warehouse. In addition to the RFID Tag number, the Mobile Inventory System Software, which runs on the computer that is part of the Mobile Inventory System, also saves the date and time of the response, the Aisle number, the Bay number, and the antenna number that was used to receive the RFID Tag information. The end result is a number of RFID Tag numbers that are saved along with when and where the tag was located.

The Mobile Inventory System Software then tallies all these data records for a particular RFID Tag number that shows the Aisle, Bay, Antenna and Reader. The RFID antennas broadcast over a relatively wide range and the same tag might be activated by more than one antenna, by the same antenna more than once and the same tag might be activated when the Mobile Inventory System is positioned in front of several different Bays. Thus, the same Item will likely have many RFID Tag records with many showing the same Aisle and Bay. The Aisle and Bay information is the Scanned Location. The same RFID tag number can be detected in many other Scanned Locations. See Table 4 for an RFID Tag listing which includes four rows for an RFID Tag having a number which ends in ACDA2. The first two rows show that the ACDA2 RFID Tag was detected at Aisle 1, Bay 1. But it was also detected at Aisle 1, Bay 2. In a real RFID Tag listing, this same RFID Tag might be detected by other Antennas as well as in other Bays.

The Mobile Inventory System Software tallies the number of times a particular location, for a particular RFID Tag, is in the Scanned RFID data. For a particular RFID Tag, there might be from one to 30 or more Scanned Locations for that tag in Tag Telemetry Data the. In addition, for a particular RFID Tag, there might be many data entries for with the same Scanned Location. The Mobile Inventory System Software then calculates the number of tag responses that show a particular Scanned Location and compares that to the total number of responses with that RFID tag number. The Scanned Location showing the highest number of location entries for that tag number is identified as being the Most Probable Location.

This process, which determines the Most Probable Location, is a critical feature of the present invention. How this process is integrated into a fully functional warehouse inventory system is discussed herein.

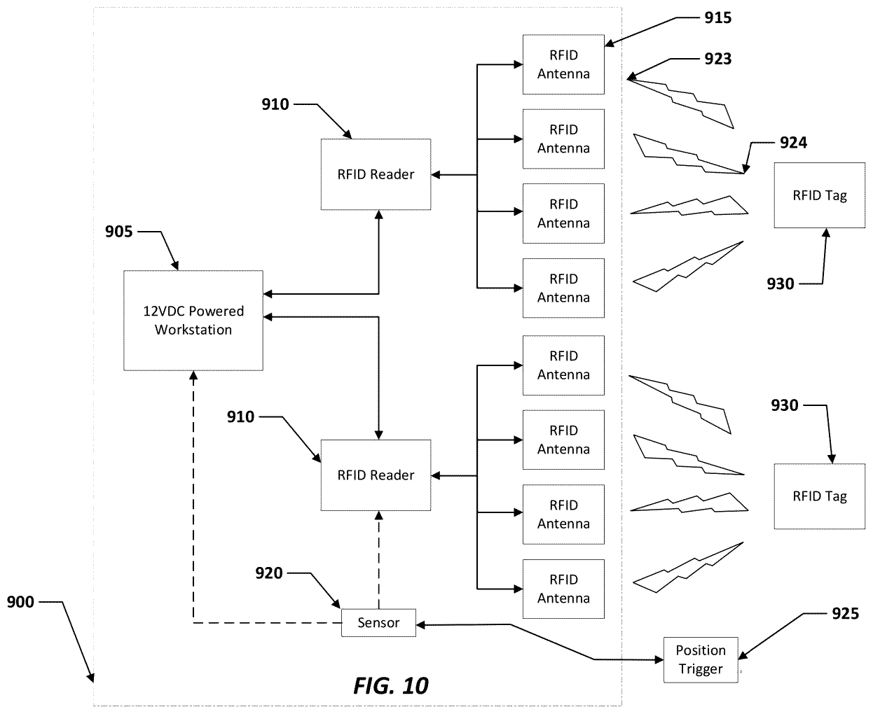

FIG. 10 is a general schematic of the overall operation of the Mobile Inventory System 900. The main component is Workstation 905. Workstation 905 is in electrical communication with one or more RFID Readers 910. The RFID Readers 910 are also in electrical communications with one or more Antennas 915. Bay Divider sensing can be achieved by some the interaction of a Position Trigger 925 and a Sensor 920. The Position Trigger 925 can be a type of operator-activated manual trigger, an optical trigger, a magnetic trigger, a bar code, a retroreflective object, a reflective object or other known trigger mechanisms. Then Sensor 920 detects a signal from Position Trigger 925 and is in electrical communication with Workstation 905. The Sensor 920 would be a complementary sensor for the particular type of Position Trigger 925 that is used. Once the Sensor 920 detects the presence of a Position Trigger 925, the Mobile Inventory System Software increments the bay counter and any subsequent RFID Tag 930 responses that are received are saved with the incremented bay counter value. The Energizing rf Signal 923 emitted by RFID Antennas 915 and received by the one or more RFID Tags 930 provides sufficient power to the one or more RFID Tags 930 to enable them to respond with a Responding rf Signal 924. The Responding rf Signal 924 is encoded with the information stored in the RFID Tag 930 and returns that information via RFID Antenna 915, to RFID Reader 910 and then to Workstation 905. Workstation 905 then stores that information, along with the date, time, Aisle, Bay and Antenna number information. The information received by Workstation 905 enables the Mobile Inventory System Software to generate the type of table shown in Table 3.

### Detailed Description of the Mobile Inventory System

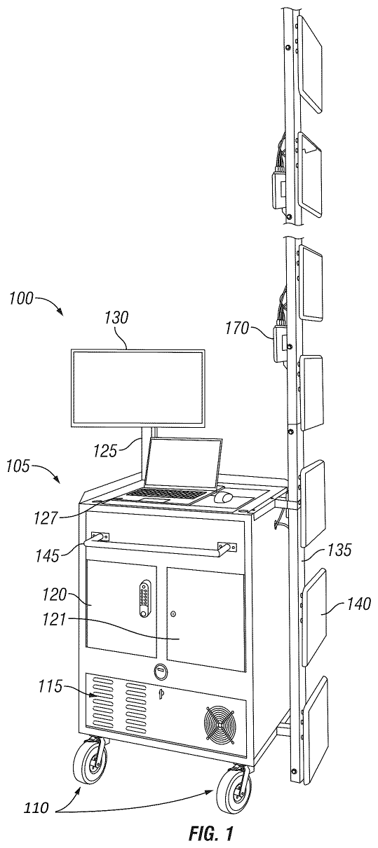

FIG. 1 shows Mobile Inventory System 100 in a typical configuration. System Cart 105 is supported on four casters. There are two front-mounted Swivel Casters 110 and two rear-mounted Motorized Casters 112 which are fixed. The Motorized Casters 112 assist the user in moving the Mobile Inventory System 100 in order to properly scan the inventory. The front interior of System Cart 105 is divided into Upper Left Cabinet 118, Upper Right Cabinet 119 and Lower Cabinet 117 (all shown in subsequent figures). Each of these interior cabinets are covered respectively by Upper Left Cabinet Door 120, and Upper Right Cabinet Door 121 and Lower Cabinet Door 115.

Secondary Monitor Support 125 is affixed to the top of System Cart 105. The associated Secondary Monitor 130 is attached to Monitor Support 125 and provides an additional video display. Workstation 127 is positioned on top of System Cart 105. Though shown in FIG. 1 as a laptop, a computer of any form factor could be used.

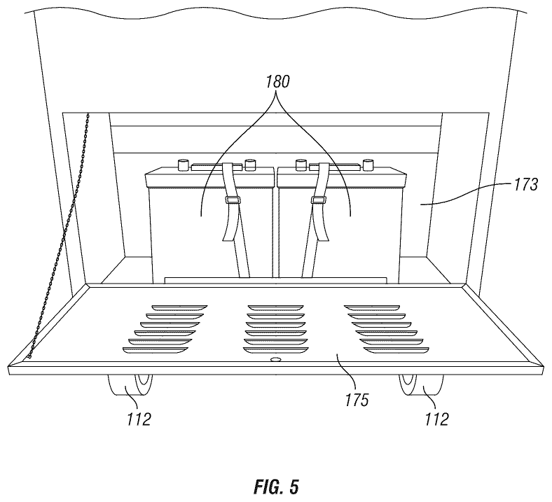

Touch Sensitive Handle 145 is used to control the fixed Motorized Casters 112, shown in FIG. 5. Touch Sensitive Handle 145 can control both the direction of rotation and the power level applied to the Motorized Casters 112 to facilitate the transport of the Mobile Inventory System 100 within the area to be scanned.

Attached to the right side of System Cart 105 is Antenna Support Mast 135. Attached to the Antenna Support Mast 135 are one or more RFID Antennas 140 and the one or more associated RFID Readers 170. There are typically four RFID Antennas 140 that are placed in electrical communication with one RFID Reader 170.

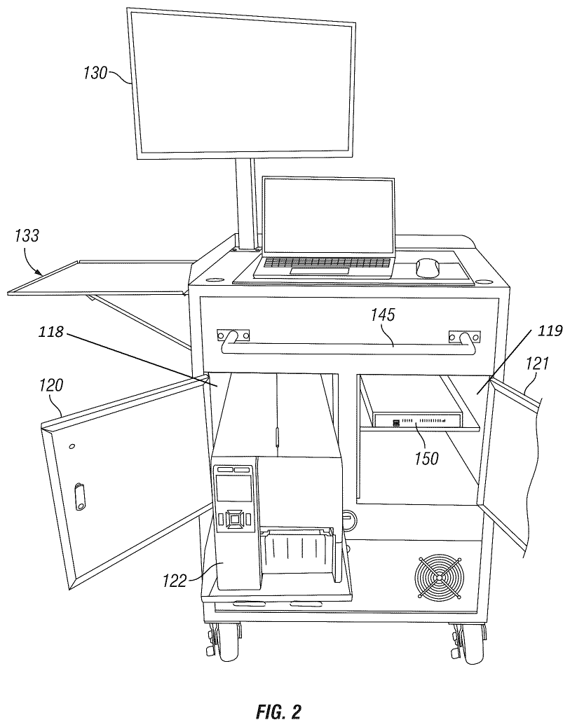

FIG. 2 shows the front of Mobile Inventory System 100. Both the Upper Left Cabinet Door 120 and Upper Right Cabinet door 121 are shown open. Positioned within the Upper Left Cabinet 118 is RFID Printer 122. RFID Printer 122 is shown positioned on a sliding platform which is shown in the extended position. This allows easier access to the RFID Printer 122. Positioned within the Upper Right Cabinet 119 is Power over Ethernet (POE) Switch 150.

Auxiliary Table 133 is shown in the horizontal, extended and latched position which provides an additional work surface. Auxiliary Table 133 can be unlatched, folded down and positioned vertically and close to the left side of System Cart 105. If additional work surface is not needed, or if the table when extended and latched causes a clearance issue, the Auxiliary Table 133 can be unlatched and folded down and out of the way.

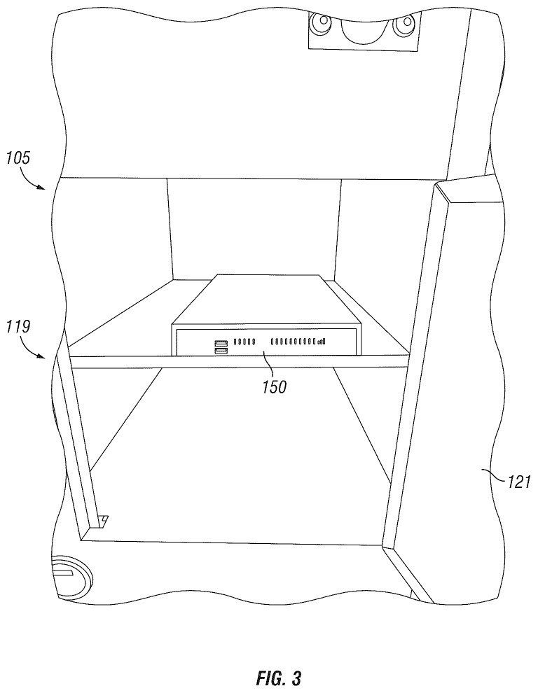

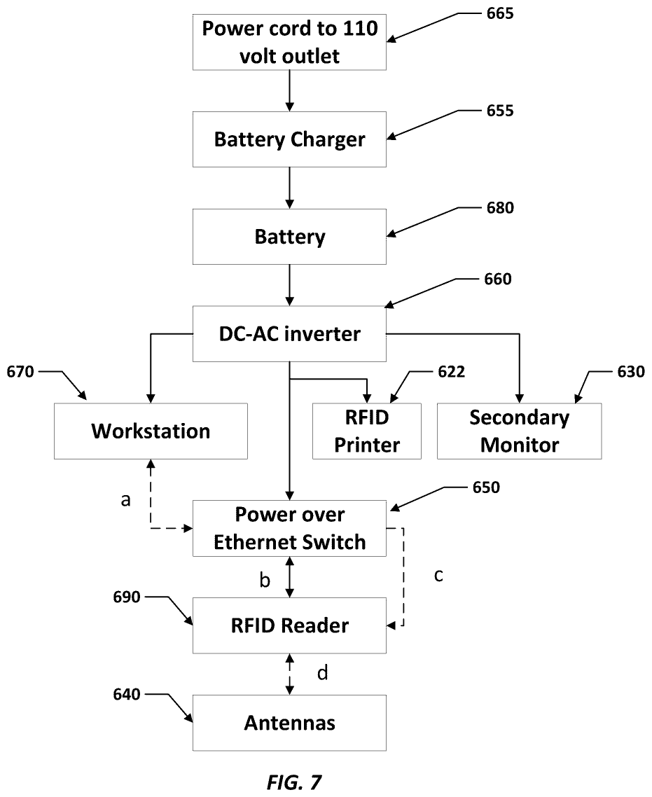

FIG. 3 is another view of Upper Right Cabinet 119. Included in this view is Power over Ethernet (POE) Switch 150 and Upper Right Cabinet Door 121. Details of how Power over Ethernet Switch 150 is incorporated in the Mobile Inventory System 100 is shown in FIG. 7.

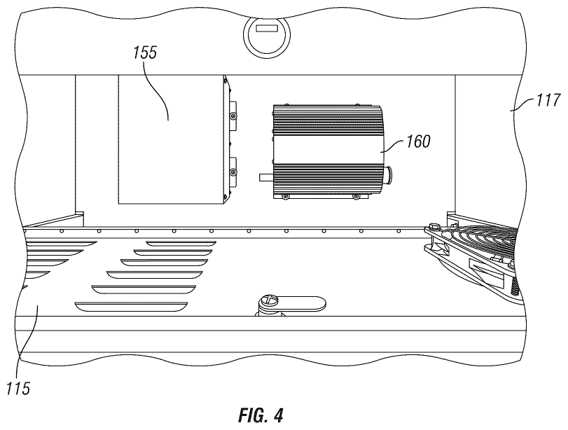

FIG. 4 shows Lower Cabinet 117 with Lower Cabinet Door 115 shown in the open position. Located within Lower Cabinet 117 is Battery Charger 155 and DC to AC Inverter 160.

FIG. 5 shows the rear of the Mobile Inventory System 100. Back Cabinet Door 175 is shown open so that the contents of Back Cabinet 173 are in view. Battery 180 (two are illustrated, but this number may vary) is placed inside Back Cabinet 173.

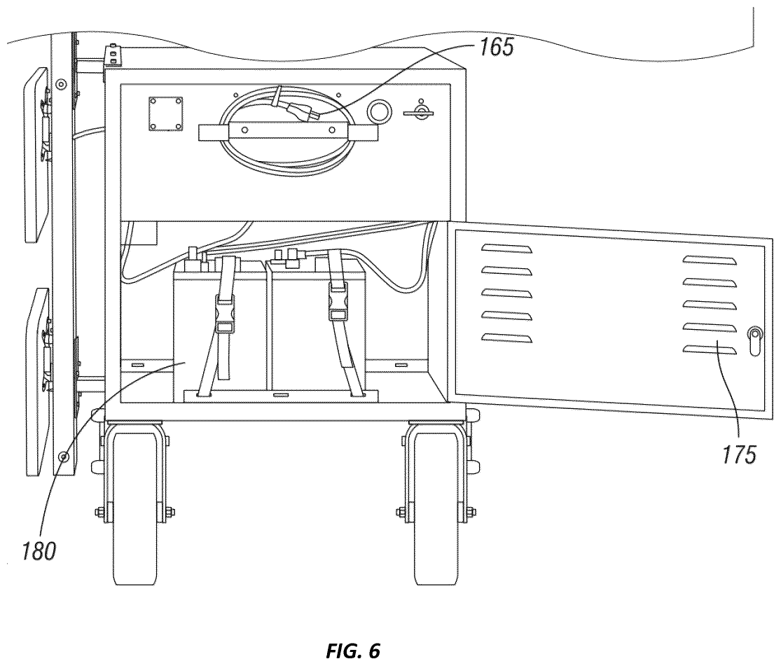

FIG. 6 is a review of Mobile Inventory System 100 with the Back Cabinet Door 175 shown in the open position. Battery 180 is shown positioned within Back Cabinet 173. Power Cord 165 is shown attached above Back Cabinet 173 on the outer surface of the back of Mobile Inventory System 100. The normal charging procedure is for the Mobile Inventory System 100 to be plugged into a standard 110-volt outlet via the Power Cord 165. This enables the Battery Charger 155 to recharge Battery 180. The battery recharging is performed when the Mobile Inventory System 100 is not being used to scan a warehouse. When the Mobile Inventory System 100 is used to scan the warehouse, the Power Cord 165 is removed from the outlet and stored as shown. Then all equipment on the Mobile Inventory System 100 is powered through DC to AC Inverter 160 which gets it power from Battery 180.

FIG. 7 is a schematic of the power distribution and charging system of the Mobile Inventory System 100. Power Cord 665 is connected to a standard 110-volt outlet. Though the Mobile Inventory System 100 is discussed herein as being powered by a 110-volt circuit, the Mobile Inventory System 100 can be configured to work with other standard electrical supply systems. The power supplied by Power Cord 665 is delivered to Battery Charger 655 which converts the incoming alternating current to DC current to charge one or more Battery 680. Typically, Battery 680 is a 12-volt battery, but the Mobile Inventory System can be configured to work with batteries of other voltages. When the Mobile Inventory System 100 is to be used perform a scan, Power Cord 665 is disconnected from the 110-volt outlet. DC-AC Inverter 160 then converts the 12-volt power from Battery 680 to 110-volt 60 cycle AC power to drive the remaining electrical components of the Mobile Inventory System 100.

Then standard 110-volt AC current is delivered to the Workstation 670, the Secondary Monitor 630, the Power over Ethernet (POE) Switch 650, and Printer 622. All of the one or more RFID Readers 690 are connected by an ethernet cable (line b) to the Power over Ethernet Switch 650. A PoE connection is designed to transmit data in both directions as well as provide power to another device. In this case the power to operate the RFID Readers 690 is provided by the PoE connection to the Power Over Ethernet Switch 650 (line c). Information that is encoded in a rf signal from the RFID Tag and sent over an rf cable to the RFID Reader (line d). The RFID Reader converts the rf signal from Antenna 640 into digital information that is electronically communicated to Workstation 670 via an ethernet cable (line a).

### Detailed Description of the Preferred Inventory Method Utilizing the Mobile Inventory System

To fully utilize the Mobile Inventory System, an existing inventory, the PI, which is saved in a predetermined format (see Table 3) is uploaded to the Mobile Inventory System Software. The PI is provided by the operators of the warehouse and may be derived from a previous inventory performed by the Mobile Inventory System, one that has been derived by physical inspection or any other means. The Mobile Inventory System can be adapted to work with a PI stored in any standard industry format as well as a proprietary format. The PI is uploaded to the computer system and made available to the Mobile Inventory System Software. Then the Mobile Inventory System is moved along one Aisle of one or more of the shelving structures in the warehouse. The Mobile Inventory System is positioned as close as reasonably safe to the front face of each shelving unit. The sample PI data in Table 3 shows eight unique RFID Tag numbers and the Aisle, Bay, Shelf and Description of each Item. In this sample table, the Description column refers to a product type. There can be multiple Items, each being the same type of product and having the same Product number, but they would have different RFID Tag numbers. The Description could be any information that is useful to the warehouse operators. It could be part numbers, SKU numbers, model numbers, etc. The warehouse operator can have the RFID Tags programmed to contain various types of data stored in any desired format to suit their needs.

As the Mobile Inventory System is moved along the front of one or more Aisles, the system will activate the RFID Tags attached to the Items on the Shelves. Activated RFID Tags will respond with an rf signal, referred to as a Response Signal, which encodes the unique identification number and optionally other data that has been hard programmed into the RFID tag. Response Signals are received by the Antennas and then passed onto to the RFID Reader, which converts the signal into digital signal information and when stored it is referred to as a Tag Data Record. Tag Data Record is then communicated to the Workstation. The Tag Data Record not only includes data transmitted by the RFID Tag, but also information as to which Antenna and Reader received the digital signal, which Aisle is currently being scanned and also the date and time the signal was received. The Mobile Inventory System, having received the Tag Data saves it locally on the Workstation and which is collectively referred to as the Tag Telemetry Data.

Table 4 is a sample table of Tag Telemetry Data. Note that there are two rows of data for RFID Tag E200643F180251F1687AD147, because that tag was activated twice and responded twice. In a real-world setting, each RFID Tag would likely respond many times as the Mobile Inventory System is moved along the Aisle and the Tag Telemetry Data could contain Tag Data for thousands of RFID Tag activations and readings.

After all the Aisles have been scanned, the Mobile Inventory System Software analyzes the list of RFID Tags in the Tag Telemetry Data with the RFID Tag information stored in the PI. The Mobile Inventory System will then generate information regarding several classes of Tags as discussed below.
1. Counted—Table 5—The term “Counted Items” as used herein means that the RFID Tag identification number has been received and that Item has been detected according to a defined criteria. Counted Items are Items that have been identified as having at least one Tag Data where Tag Data shows the Item as being within one Bay number of where the PI shows that Item should be located. For example, assume that the PI indicates that an Item, with a specific RFID Tag, is located at Aisle 1, Bay 3. If any entry in the Tag Telemetry Data captured by the scanning operation indicates that an Item with that same RFID Tag is found at Aisle 1, Bay 2 or Aisle 1, Bay 4, then that Item will be considered to have been counted and that Item will be marked in the PI as “READ” along with the date and time that the Tag Data was collected (see Table 5). Generally, only one RFID Tag response out of many with the same RFID Tag has to meet the criteria above for an Item to be considered a Counted Item and therefore located in the warehouse and likely to be at or very near the Location indicated in the PI. However, this criteria is adjustable within the Mobile Inventory System Software.
2. Potential Losses—Table 6—These are Items listed in the PI, but no Tag Data was detected that contained that RFID Tag number (see Table 6). Note that there are entries for Products 15 and 16 shown in Table 5. Table 5 shows that the two RFID Tag numbers for these two Items that did not contain any information in the READ column and the READ TIME column. That indicates that these two RFID Tags were not counted (i.e., detected) and might be considered lost. However, an RFID Tag might be blocked by other packages and/or the RFID Tag has been physically damaged and thus unable to respond to the Energizing rf signal.

A CSV (comma-separated variable or comma-separated values) file of these Potential Loss Items can be generated which can be downloaded/copied to a hand-held RFID Scanner which some users might use to identify the location of the potentially lost Item. This CSV file contains the RFID Tag and the Aisle, Bay, Shelf data from the PI for each of the potentially lost Items. The hand-held Scanner can be set in Finder Mode. In Finder Mode, the user inputs an RFID Tag number. The closer the scanner is to an Item with the entered RFID Tag, the faster and louder the hand-held scanner beeps. The hand-held scanner can be passed over Items in the general location where the Item was supposed to be while the user also conducts a physical and visual inspection of that area. RFID Tags could be blocked by other boxes, tools left on Shelves, or metal parts of the shelving structure or metal packaging of the Item itself. Sometimes the RFID Tag can be damaged or poorly manufactured and have a weak signal that can only be detected by a hand-held unit that is placed very near the RFID Tag.

If the Item is not found by this inspection of the area immediately around the area indicated by the PI, then other areas of the warehouse can be inspected with the scanner. Such areas could include the loading dock, shipping, receiving and others. If the Item is found, the Item is placed in the proper location and the PI is updated with the new location information and the Item is flagged as having been counted. If the Item is placed in the same location as the Location shown in PI, then Location data in the PI does not need to be updated.
3. Misplaced Items—Table 7—These are Items that have the same RFID Tag as an Item in the PI but the Tag Telemetry Data shows that it is in an entirely different location than that shown in the PI. If the Item is located just one Bay number away from the corresponding Bay number in the PI, then it is classified as a Counted Item (see Paragraph 1 Counted Table 5 above). If the Tag Telemetry Data shows that it is more than one Bay number away from the that shown in the PI, then the Item is classified as Misplaced.

The Mobile Inventory System Software will create and print out a Most Probable Location Table for the Misplaced Items, which is a listing of all the Scanned Locations of the Misplaced Items that were identified during the Inventory Scan and the number of times those Scanned Locations were read.

For example, data for Item #3 in Table 7 shows that there were 60 RFID Tag responses showing that that the Item was located at Aisle 1/Bay 1. Please note that column “Item #” is included here to facilitate discussion and is ordinarily not included as part of Table 7. Table 7 also shows that there were 26 RFID Tag responses showing that the Item was located at Aisle 1/Bay 2. There were 86 RFID Tag responses in total. Therefore, the probability of the Item being located at Aisle 1/Bay 1 is 60/86×100 or 70%. Therefore, Aisle 1/Bay 1 would be the Most Probable Location.

The Most Probable Location Table for the Misplaced Items is generated and made available for users to aid in the finding of the Misplaced Items. The user would ordinarily start looking at the location shown in Table 7 having the highest probability of being the actual location for a specific RFID tag. A CSV file is also generated which can be downloaded/copied to a hand-held RFID Scanner which some users might use to find the precise location of a Misplaced Item. The hand-held RFID Scanner can be set in Finder Mode (or something equivalent) to search for Misplaced Items. A particular RFID Tag is selected from all of the RFID Tags stored in a CSV file. An alternative method is for the user to manually enter the full RFID number into the hand-held scanner. The scanner can be passed over Items in the general location where the Item was supposed to be while a user also conducts a physical inspection of that area. RFID Tags could be blocked by other boxes, tools left on Shelves or metal parts of the shelving structure. If the Item is not found by this inspection, the other areas of the warehouse can be inspected with the scanner. Such areas could include the loading dock, shipping, receiving and others. If the Item is found, the Item is placed in the proper location according to the PI and the Item is indicated as Counted.

Using the Most Probable Location as the starting point for the search for this Misplaced Item would save time by initiating the search in location that is very likely to be where the Item would be found. This saves significant time and manpower by concentrating the search in a much smaller area rather than blindly searching the whole warehouse for the misplaced Item.

If the Item is in the intended location in the warehouse and the PI data is incorrect, then the PI is updated. Even if the Item is stored in the proper location, a typo during data entry can result in a Misplaced Item.
4. Potential Gains—Table 8—If the Tag Telemetry Data shows an RFID Tag number that is not listed in the PI, these Items are classified as Potential Gains (see Table 8). The Mobile Inventory System Software will create and print a Most Probable Location Table for the Potential Gains (described in paragraph 3 above). A CSV file is also generated which can be downloaded and/or copied to a hand-held RFID Scanner which some users might use to find the exact location of a Potential Gain Item. Because this Item is not in the PI, it needs to have the RFID Tags physically inspected in order to help determine a possible cause of why this Item was not in the PI. Once the precise location has been identified, it can be physically inspected to determine a possible source of the error; confirm that the RFID Tag is correct for the actual Item; enter the Item location information into the PI; or perform whatever other action is appropriate for the warehouse inventory reconciliation process.

### Details of the Inventory Method of the Current Invention

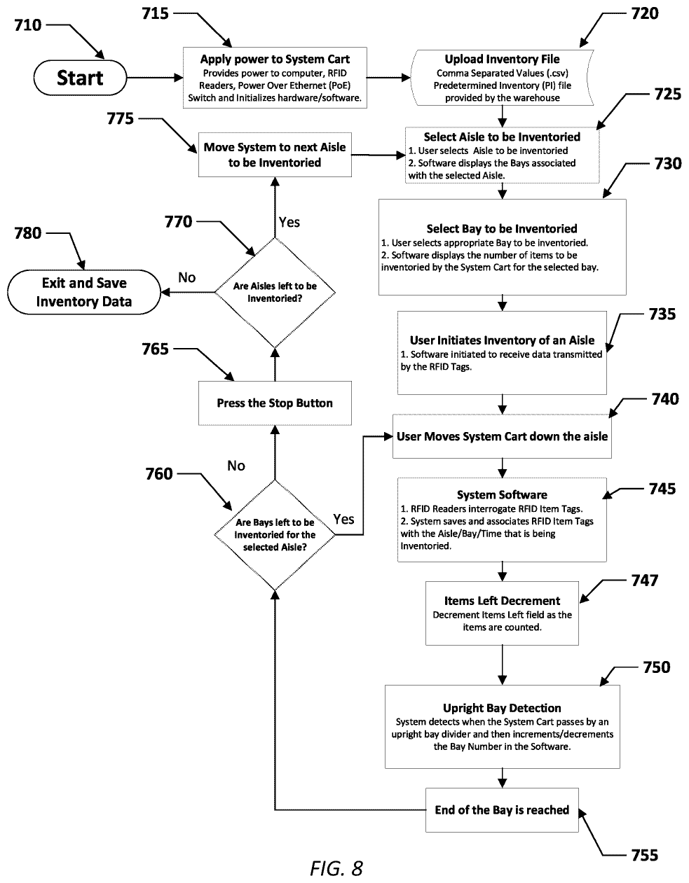

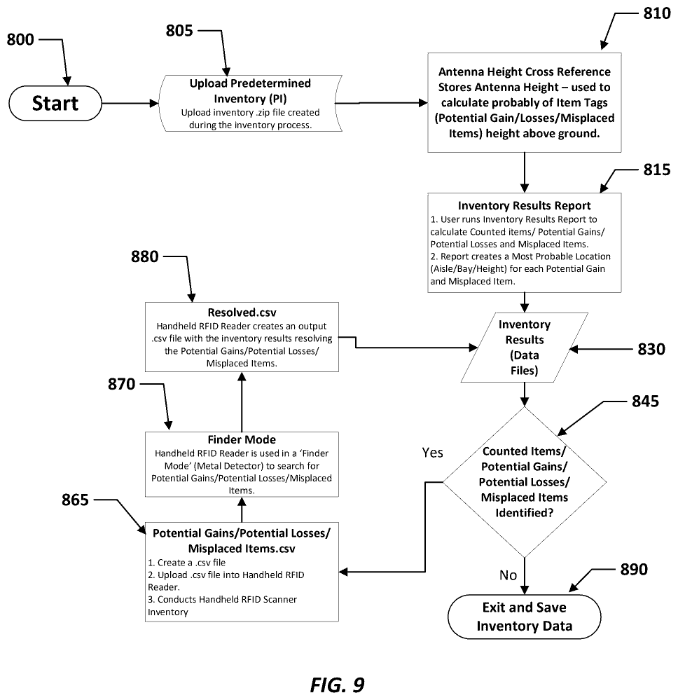

The Inventory method of the Present Invention is generally divided into two operations. The first is the actual physical Scanning Operation of the warehouse space by the movement of the Mobile Inventory System along the Aisles in the warehouse. The second operation is the processing of that information into useable data that is then optionally printed and/or stored onto physical media such as flash drives, a hard copy which is provided to a warehouse person and optionally upload to one or more of a cloud storage site, a network addressable storage device (NAS), OneDrive and DropBox. The Scanning Operation of the Present Invention is depicted in the flowchart shown in FIG. 8 and discussed in Table I. The Data Processing Operation process is depicted in the flowchart shown in FIG. 9 and discussed in Table II below.

TABLE 1
Scanning Operation
(See FIG. 8)
Though certain steps in this process are presented as
occurring in a certain order, many of these steps, as
would be well-known to one skilled in the art, could be
performed in a different order or combined into a single step.

| Step No. | Description |
|---|---|
| 710 | Start |
| 715 | All systems are powered on. This includes the Workstation, the RFID readers, the |
| | Power over Ethernet (POE) adapter, and the Secondary Monitor. The Mobile |
| | Inventory System Software is loaded and initialized. The main User Interface (UI) |
| | screen is displayed. |
| 720 | The data from the Predetermined Inventory is loaded into the Mobile Inventory |
| | System Software. The PI is provided by the operator of the warehouse which |
| | houses the Items to be inventoried. Though details are discussed elsewhere herein, |
| | the loaded data file is typically a CSV file, which is a standard spreadsheet file |
| | format which can generated by Microsoft Excel, Google Sheets, or similar |
| | programs. |
| 725 | The user inputs an Aisle number by any of a number of standard input |
| | methodologies. After having input an Aisle number, the Mobile Inventory System |
| | Software will display the number of Bays that the PI indicates are in the selected |
| | Aisle. After having input an Aisle number, the Mobile Inventory System Software |
| | will display the number of Bays that the PI shows are in the selected Aisle. |
| 730 | The user then inputs a starting Bay number by any one of a number of standard |
| | methods known in the industry. The system allows a user to select from the |
| | highest numbered Bay to the lowest or vice versa. Efficient scanning will often |
| | require the User to scan from the lowest to the highest numbered Bay in one Aisle |
| | and then from highest to lowest number Bay on the facing Aisle. |
| 735 | The Mobile Inventory System Software initializes the RFID Readers and |
| | Antennas. |
| 740 | The System Cart is then moved by the user down the Aisle. Though having the |
| | Mobile Inventory System physically pushed by a human operator, any number of |
| | more expensive and/or sophisticated options are within the scope of the present |
| | invention. These would include, but not be limited to battery-operated drive |
| | systems and even automated systems that could have a predetermined path |
| | through the warehouse downloaded into the Mobile Inventory System. |
| 745 | The RFID readers send RFID tag Energizing rf Signals which are broadcast from |
| | the antennas. Each of the RFID Tags that can receive the Energizing rf signals, |
| | will be energized, and will send a Responding rf Signal with the information that |
| | the RFID Tags have been programmed to provide. Some RFID Tags may not be |
| | positioned to receive the Energizing rf signal because of placement on the Shelves |
| | or possible damage to the tag. |
| | The Mobile Inventory System Software will capture and store the information |
| | encoded in each Responding rf Signal that the Readers can receive. The RFID |
| | Tag information, along with the Aisle number, Bay number and date and time of |
| | each transmission, and any other optional information is stored by Mobile |
| | Inventory System in the RFID Tag Telemetry File. |
| 747 | An optional feature is that the UI will initially display the total number |
| | of unique RFID Tags expected in the selected Bay, based upon the PI. As the |
| | Mobile Inventory System is moved down the Aisle, each time a new RFID Tag is |
| | detected, this displayed number is decremented. This is used as a general indicator |
| | of the proper operation of the hardware and the Mobile Inventory System Software. |
| 750 | Bay Detection. Each time the System Cart passes directly in front of a Bay |
| | Divider, that transition is detected. There are several methods for detection |
| | of a Bay Divider: |
| | 1. Visual detection by the User who then manually adjusts the Bay Number by |
| | input to the UI by using a touch pad, mouse, keyboard, voice recognition or other |
| | means. |
| | 2. Optical Detection - Standard optically-based systems can be utilized to detect |
| | a Bay Divider and thus the transition to a new Bay. Optical tags can be placed on |
| | each Bay Divider. The marking might be a predefined color, bar code, QRS code |
| | and other similar markings. An optical detector is included in the Mobile |
| | Inventory System which is designed to sense and identify the optical tag. No |
| | product information is contained in the optical tag. It is simply used to signal |
| | a Bay transition to the Mobile Inventory System Software. RFID Tags might be |
| | used, but because the antennas radiate the rf energy broadly, the ability to |
| | precisely detect the presences of a Bay Divider would be difficult. However, an |
| | antenna that is very low powered could be used such that the antenna would have |
| | to be very near the special RFID Bay Divider tag in order to receive a return |
| | signal from the RFID Bay Divider tag. |
| | An additional method to signal the presence of a Bay Divider would be to attach a |
| | magnet to the Bay Divider and detect the presence of the magnet with a magnetic- |
| | activated switch attached to the movable System Cart. Other options have already |
| | been disclosed. |
| 755/760 | Each time a Bay Divider is detected (Step 750), this is considered to be the end |
| | of the current Bay. The Mobile Inventory System Software determines if there are |
| | more Bays to be scanned in the current Aisle (Step 760). If there are additional |
| | Bays, then the Mobile Inventory System Software goes to Step 740, and the |
| | Mobile Inventory System continues to be moved down the currently selected |
| | Aisle to capture additional RFID Tag information. If the Mobile Inventory System |
| | Software determines that there are no further Bays in the currently selected Aisle, |
| | then the Mobile Inventory System Software proceeds to Step 765 |
| 765 | The User initiates a STOP by an input to the UI by utilizing a touch pad, a mouse, |
| | a keyboard, a voice recognition or by other means. The STOP FUNCTION |
| | disables the transmission and receiving function of the RFID reader. The STOP |
| | FUNCTION could be implemented in the Mobile Inventory System Software. If |
| | a Bay Divider has been sensed and there are no more Bays in the current Aisle to |
| | be scanned, the Mobile Inventory System Software can then implement the STOP |
| | function. |
| 770 | Does data in PI indicate that there are additional Aisles to be scanned? If so, |
| | the Mobile Inventory System Software proceeds to Step 775, and additional Aisles |
| | are scanned. If not, the Mobile Inventory System Software proceeds to Step 780. |
| 775 | The Mobile Inventory System is moved to the next Aisle to be scanned, and the |
| | Mobile Inventory System Software returns to Step 725. |
| 780 | The Mobile Inventory System Software terminates operation and saves and closes |
| | any open data and system files, which are now available for review and/or |
| | additional data processing. |

TABLE 2
Data Processing Operation
(See FIG. 9)
Though certain steps in this process are presented as
occurring in a certain order, many of these steps, as
would be well-known by one skilled in the art, could be
performed in a different order or combined into a single step.

| Ref. No | Description |
|---|---|
| 800 | START |
| 805 | Access and load the PI data. Also access and load the Tag Telemetry Data |
| | gathered and saved during the physical scan of the stored Items by the Mobile |
| | Inventory System. The Tag Telemetry Data may be saved as a ZIP file, any |
| | other standard data file format or saved in any predefined data format. |
| 810 | Access/Verify Antenna Height Data. Antenna Height Data is the physical |
| | height above the ground of the center of each Antenna. This correlation will be |
| | used in calculating the approximate height in feet above ground for an identified |
| | Item. The heights of the various Antennas are physically measured for a |
| | particular System Cart and stored in the Mobile Inventory System Software as |
| | part of the original system installation. Shelf configuration in any warehouse |
| | may be different in different locations in a warehouse. In addition, shelf |
| | configuration can change over time as the mix of Items needed to stored can |
| | change. Actual identification of a particular shelf is not practical. However, |
| | the Mobile Inventory System Software does store antenna number information with |
| | each RFID Tag record which can optionally be made available, or it can be |
| | extracted by the warehouse staff from the various information file provided to |
| | the warehouse. |
| 815 | Inventory Results Report: |
| | a. At the user's request, the Mobile Inventory System Software generates an |
| | Inventory Results Report which gathers and prints information regarding the |
| | following classes of Items: |
| | Potential Gains |
| | Potential Losses, |
| | Misplaced Items, and |
| | Counted Items. |
| | The Tag Telemetry Data is evaluated and a condensed data list of RFID |
| | Tags which represents the Most Probable Location for each RFID Tag deemed |
| | to have been Counted, is a Potential Gain or a Potential Loss. No Most Probable |
| | Location cannot be calculated for Potential Losses because no RFID Tag was |
| | detected at all during the scan for Potential Losses. |
| 830 | The condensed list (all four data categories as defined in Step 815) is stored |
| | as a CSV file. |
| 845 | Potential Gains/Potential Losses and Misplaced Items are determined by |
| | comparing the Final Inventory Results with the PI in which the Mobile |
| | Inventory System Software executes the appropriate algorithmic steps. If |
| | required, the Mobile Inventory System Software will create an output CSV file |
| | to be used during a supplemental handheld RFID scanner inventory. |
| 865 | Steps 865, 870 and 880 are optional. One of three CSV files is imported into a |
| | handheld RFID Scanner. Two of the CSV files contain the Most Probable |
| | Locations for the Potential Gains and the Misplaced Items. The CSV file for the |
| | Potential Losses contains the location data from the PI. The user would start |
| | scanning at the last known locations in the Potential Losses file and expand the |
| | area scanned if needed. These are the three categories that could benefit from a |
| | handheld scan. The CSV files allow the user to conduct a supplemental |
| | handheld RFID scanner. |
| 870 | Handheld RFID Scanner has ability to search for and potentially precisely |
| | locate Potential Gains, Potential Losses and Misplaced Items using the |
| | handheld scanner in Finder Mode. |
| 880 | Information for any RFID Tags that are located processed by the Mobile |
| | Inventory System Software and add new record or updates existing records in |
| | the current CSV that has been uploaded into the handheld scanner. This updated |
| | CSV is then uploaded to the Mobile Inventory System where the PI is updated |
| | with the new supplemental data. The Mobile Inventory System Software then |
| | moves to Step 830. |
| 890 | Exit and Save Inventory Data. Since all discrepancies have been resolved, the |
| | program goes to Step 845 and then 890 where the updated PI is then uploaded |
| | back to the warehouse inventory system. |

TABLE 3
Predetermined Inventory (PI)

| RFID | Aisle | Bay | Shelf | Description |
|---|---|---|---|---|
| E200643F18041531687AD854 | 1 | 1 | A | Product 1 |
| E200643F180168B1687ACDA2 | 1 | 2 | B | Product 2 |
| E200643F1803B5B1687AD6D6 | 1 | 3 | C | Product 4 |
| E200643F18035971687AD565 | 2 | 1 | B | Product 3 |
| E200643F18035871687AD561 | 2 | 3 | B | Product 1 |
| E200643F180122F1687ACC8B | 3 | 2 | A | Product 2 |
| E200643F1800E0B1687ACB82 | 3 | 3 | A | Product 5 |
| E200643F1800E1B1687ACB86 | 3 | \4 | C | Product 5 |

For demonstration purposes the Description column has been populated with sample information.

TABLE 4
RFID Tag Telemetry Data

| | | | | | Reader | Antenna |
|---|---|---|---|---|---|---|
| RFID Tag No. | Aisle | Bay | Read | Read Date/Time | Number | Port Num. |
| E200643F180169B1687ACDA6 | 1 | 1 | 1 | 2024040111:46:22 | 1 | 1 |
| E200643F180251F1687AD147 | 1 | 1 | 1 | 20240401-11:46:23 | 1 | 1 |
| E200643F180251F1687AD147 | 1 | 1 | 1 | 20240401-11:46:23 | 1 | 1 |
| E200643F180168B1687ACDA2 | 1 | 1 | 1 | 20240401-11:46:23 | 1 | 1 |
| E200643F180168B1687ACDA2 | 1 | 1 | 1 | 20240401-11:46:23 | 1 | 1 |
| E200643F180168B1687ACDA2 | 1 | 2 | | 20240401-11:49:23 | 2 | 1 |
| E200643F180168B1687ACDA2 | 1 | 2 | | 20240401-11:49:23 | 2 | 1 |
| E200643F18035871687AD561 | 1 | 1 | 1 | 20240401-11:46:23 | 1 | 1 |
| E200643F180122F1687ACC8B | 1 | 1 | 1 | 20240401-11:46:23 | 1 | 1 |
| E200643F1803B4B1687AD6D2 | 1 | 1 | 1 | 20240401-11:46:23 | 1 | 1 |
| E200643F180201B1687AD006 | 1 | 1 | 1 | 20240401-11:46:23 | 1 | 1 |
| E200643F1800E1B1687ACB86 | 1 | 1 | 1 | 20240401-11:46:23 | 1 | 1 |

This is only a very small sample of rows from the full Telemetry CSV file. The Telemetry CSV file can contain hundreds of thousands of rows.

TABLE 5
Counted Inventory Results

| RFID Tag No. | Aisle | Bay | Shelf | Description | Read | Read Date and Time |
|---|---|---|---|---|---|---|
| E200643F18041531687AD854 | 1 | 1 | A | PRODUCT 1 | 1 | 20240401-11:46:23 |
| E200643F180168B1687ACDA2 | 1 | 1 | B | PRODUCT 2 | 1 | 20240401-11:46:23 |
| E200643F1803B5B1687AD6D6 | 1 | 1 | A | PRODUCT 3 | 1 | 20240401-11:46:23 |
| E200643F18035971687AD565 | 1 | 1 | B | PRODUCT 4 | 1 | 20240401-11:46:23 |
| E200643F18035871687AD561 | 1 | 1 | A | PRODUCT 5 | 1 | 20240401-11:46:23 |
| E200643F180122F1687ACC8B | 1 | 1 | B | PRODUCT 6 | 1 | 20240401-11:46:23 |
| E200643F1800E0B1687ACB82 | 1 | 1 | A | PRODUCT 7 | 1 | 20240401-11:46:23 |
| E200643F1800E1B1687ACB86 | 1 | 1 | B | PRODUCT 8 | 1 | 20240401-11:46:23 |
| E200643F180251F1687AD147 | 1 | 1 | C | PRODUCT 9 | 1 | 20240401-11:46:23 |
| E200643F180169B1687ACDA6 | 1 | 1 | A | PRODUCT 10 | 1 | 20240401-11:46:22 |
| E200643F1802FDF1687AD3F7 | 1 | 1 | B | PRODUCT 11 | 1 | 20240401-11:46:23 |
| E200643F1800E0F1687ACB83 | 3 | 5 | E | PRODUCT 12 | 1 | 20240401-11:48:51 |
| E200643F18069131687AE244 | 3 | 5 | F | PRODUCT 15 | — | — |
| E200643F18070471687AE411 | 3 | 5 | A | PRODUCT 16 | — | — |
| E200643F180201F1687AD007 | 3 | 5 | B | PRODUCT 17 | 1 | 20240401-11:48:44 |
| E200643F18025131687AD144 | 3 | 5 | C | PRODUCT 17 | 1 | 20240401-11:48:48 |

This is a modified table with many rows not included for convenience. Note however that this final Counted Inventory Results has RFID Tags ‘AE244 and ‘AE411 with the READ column and READ DATE and TIME column without any date or time. This is because they were not read (Counted) during the warehouse scan. The information for these two tags is the same as the tags listed in the Potential Losses spreadsheet as shown immediately below. Because there was no actual RFID data collected for these two Items, the location data shown above in Table 5 and below in Table 6 comes from the PI data which is the expected location data.

Misplaced Items are not indicated because they are more than one Bay location away from the location listed in the PI. Potential Gains are not indicated because they were not listed anywhere in the PI. The Misplaced Items and Potential Losses are handled as discussed below.

TABLE 6
Potential Losses

| RFID Tag No. | Aisle | Bay | Shelf | Description |
|---|---|---|---|---|
| E200643F18069131687AE244 | 3 | 5 | F | PRODUCT 15 |
| E200643F18070471687AE411 | 3 | 5 | A | PRODUCT 16 |

This table shows Items that were listed in the PI but not counted (i.e., detected) during the RFID scan of the warehouse. The information in the AISLE, BAY, SHELF and DESCRIPTION column are taken from the PI and are the anticipated location of the Items tagged ‘AE244 and ‘AE411.

TABLE 7
Most Probable Location Table - Misplaced Items

| Item # | RFID Tag No. | Aisle | Bay | Count | Probability % |
|---|---|---|---|---|---|
| 1 | E2801170000002136B97F307 | 1 | 1 | 10 | 100* |
| 2 | 2F120394330343200000FD0D | 1 | 1 | 6 | 100* |
| 3 | 2F120333134343299A707A01 | 1 | 1 | 60 | 70* |
| ″ | 2F120333134343299A707A01 | 1 | 2 | 26 | 30 |
| 4 | E2801170000002136B97F3C7 | 1 | 1 | 107 | 12.7 |
| ″ | E2801170000002136B97F3C7 | 1 | 2 | 57 | 6.8 |
| ″ | E2801170000002136B97F3C7 | 1 | 3 | 45 | 5.3 |
| ″ | E2801170000002136B97F3C7 | 1 | 4 | 22 | 2.6 |
| ″ | E2801170000002136B97F3C7 | 1 | 5 | 90 | 10.7 |
| ″ | E2801170000002136B97F3C7 | 2 | 1 | 70 | 8.3 |
| ″ | E2801170000002136B97F3C7 | 2 | 2 | 50 | 5.9 |
| ″ | E2801170000002136B97F3C7 | 2 | 3 | 55 | 6.5 |
| ″ | E2801170000002136B97F3C7 | 2 | 5 | 46 | 5.5 |
| ″ | E2801170000002136B97F3C7 | 3 | 1 | 52 | 6.2 |
| ″ | E2801170000002136B97F3C7 | 3 | 2 | 38 | 4.5 |
| ″ | E2801170000002136B97F3C7 | 3 | 3 | 47 | 5.6 |
| ″ | E2801170000002136B97F3C7 | 3 | 4 | 4 | 0.5 |
| ″ | E2801170000002136B97F3C7 | 3 | 5 | 115 | 13.6* |
| 5 | 2F12039373439390060C9754 | 1 | 1 | 61 | 100* |
| 6 | E2801170000002136B967DE7 | 1 | 1 | 17 | 26.6 |
| ″ | E2801170000002136B967DE7 | 1 | 2 | 18 | 28.1* |
| ″ | E2801170000002136B967DE7 | 1 | 3 | 12 | 18.8 |
| ″ | E2801170000002136B967DE7 | 1 | 4 | 7 | 10.9 |
| ″ | E2801170000002136B967DE7 | 1 | 5 | 10 | 15.6 |

Note:
this is only the first 25 rows of a hypothetical Misplaced Items CSV. This table shows the data for six RFID Tags. A separate column located along the left-hand side of table indicates with identical numbers used to indicate one of the six RFID Tags in the table.
The “*” is used to indicate the Most Probable Location for that particular RFID Tag.
Items #1, #2 and #5 are counted in only one Aisle and Bay. Therefore, the probability of finding these Items in the one Aisle/Bay location is 100%.
Items #3, #4 and #6 were counted in more than one Aisle/Bay location.

Each row also includes a Count cell showing how many times the Item was counted in that Aisle/Bay location. Item #3 (the third and fourth rows) indicate that the Item with tag ‘07A01 detected 60 times in Aisle/Bay location 1,1 and 26 times in Aisle/Bay location 1,2. Therefore the probability that the Item is in the Aisle 1/Bay 1 location is 70%. The percentage of probability is calculated by dividing the number of counts in Aisle/Bay 1,1 (60) by the total number of counts for Item #3 (86). Thus, the probability is calculated as 60÷(60+26) which is 70%.

Potential Gains are any Item whose RFID Tag was captured during the scan but is not listed in the PI. Though not shown, a table similar to Table 7 would be generated to show a Most Probable Location for each of the Potential Gain Items. The Most Probable Location is then used to provide the data for Table 8. Optionally, Table 8 data can also be downloaded to a hand-held RFID detector in order to facilitate finding the precise location for an Item listed in the Potential Gains Table.

TABLE 8
Potential Gains Table

| RFID Tag No. | Aisle | Bay | Read | Read Time |
|---|---|---|---|---|
| E2801170000002136B97F307 | 1 | 1 | 1 | 20240401-11:46:23 |
| 2F120394330343200000FD0D | 1 | 1 | 1 | 20240401-11:46:23 |
| 2F120333134343299A707A01 | 1 | 1 | 1 | 20240401-11:46:23 |
| E2801170000002136B97F3C7 | 1 | 1 | 1 | 20240401-11:46:23 |
| 2F12039373439390060C9754 | 1 | 1 | 1 | 20240401-11:46:23 |
| E2801170000002136B967DE7 | 1 | 1 | 1 | 20240401-11:46:23 |
| E2801170000002136B980D67 | 1 | 1 | 1 | 20240401-11:46:23 |
| 2F12030554A353500011C3D4 | 1 | 1 | 1 | 20240401-11:46:23 |

This exemplary table might depict a portion of a whole Potential Gains file.

While the invention has been described in conjunction with the specific embodiments thereof, it is to be understood that the foregoing description as well as the examples are intended to illustrate and not limit the scope of the invention. Other aspects, advantages and modifications within the scope of the invention will be apparent to those skilled in the art to which the invention pertains.

1. A method of reconciling an existing warehouse inventory with a real-time inventory of items that are each tagged with an electronic item identifier and said items being stored in identifiable locations, the location comprising the elements of bays and shelves, comprising the steps of:
a. providing a movable structure;
b. providing one or more electronic identifier antennas located at one or more known positions on the movable structure;
c. providing one or more stored items;
d. providing one or more identifiable electronic readers wherein each of said one or more identifiable electronic readers is in electrical communication with at least one of said electronic identifier antennas, wherein each of said electronic identifier antennas generates an activating electronic signal which is received by one or more of the electronic item identifiers which then sends a responding electronic signal to the one or more antennas:
e. providing a means to record the horizontal distance that the movable structure has traversed while the movable structure is moved past the stored items:
f. said responding electrical signal has a unique identifying signature encoded within the responding electronic signal and optionally encoded within the responding electronic signal other information as desired:
g. providing a computer in electrical communication with said one or more electronic readers, said computer comprising an input device, a processor, a visual display, a data storage means, and an amount of random-access memory; and a means to communicate electronically with other computers and data storage devices:
h. causing said movable structure to move past one or more of the items;
i. providing inventory software that operates on said computer, said inventory software receives from the one or more electronic readers one or more of the unique identifying signatures and then electronically stores all of the unique identifying signatures that are received from the electronic readers;
j. said inventory software further stores along with each unique identifying signature the identifiable location of each item currently being scanned, the reader identifier that received the specific identifying signature, the antenna that received the electronic signal from the specific item identifier, the horizontal distance that the movable structure has traversed when the specific identifying signature has been received and the date and time the signal was detected that is associated with each unique identifying signature received by the inventory software; and
k. said software generates a most probable location list for all or a subset of all the data stored by the scan by performing the following:
i. generating a list of all the RFID tag responses for one specific RFID number:
ii. count the total number of RFID tag responses for a specific location:
iii. the location that had the highest computed bay metric derived from RFID tag responses is deemed to be the most probable location; and
iv. if there are two or more locations which have the same computed bay metric, then each of them is deemed the most probable location.

2. A method of claim 1 wherein a Counted subset of all of the data stored by the scan is generated by selecting all RFID tag responses in the scan in which the stored location for that item is within a user-defined distance from the location data in the predetermined inventory for an item having that same RFID tag number.

3. A method of claim 1 wherein a Misplace subset of all of the data stored by the scan is generated by identifying all RFID tag responses that have location information that is different from that location information stored in the existing warehouse inventory.

4. A method of claim 3 wherein said difference between the location of an item as identified in the scan and the location of the item as stored in the existing warehouse inventory, is expressed as the difference in the identified bay numbers and/or aisle numbers, is a user-definable parameter.

5. A method of claim 1 wherein a Potential Gains subset of all of the data stored by the scan is generated by identifying all RFID tag responses which do not appear in the existing warehouse inventory.

6. A method of claim 1 wherein a Potential losses subset of all of the data statured by the scan is generated by identifying all items in the predetermined inventory that do not appear in the scanned data.

7. A method of claim 1 wherein said movable structure further includes a vertical support upon which are mounted one or more of said readers and one or more of said antennas.

8. A method of claim 7 wherein said vertical support is between 5 and 30 feet tall.

9. A method of claim 1 wherein said movable structure is supported by casters and moved by at least one of more motorized casters.

10. A method of claim 9 wherein said movable structure further includes a manual controller which can control speed and rotation direction of the motorized casters.

11. A method of claim 1 wherein the means to record the horizontal distance the movable structure has traversed is a manual input that the user activates when a predetermined distance has been traversed.

12. A method of claim 1 wherein the means to record the horizontal distance the movable structure has traversed is selected from group consisting of an optical trigger, a magnetic trigger, a bar code, a retroreflective item or reflective item.
